(19) United States
(12) Patent Application Publication
(10) Pub. No.: US 2025/0293841 A1
(43) Pub. Date: Sep. 18, 2025

(54) TRANSMISSION TIMING ADJUSTMENT METHOD AND APPARATUS, AND STORAGE MEDIUM

(71) Applicant: BEIJING XIAOMI MOBILE SOFTWARE CO., LTD., Beijing (CN)

(72) Inventor: Yajun ZHU, Beijing (CN)

(73) Assignee: BEIJING XIAOMI MOBILE SOFTWARE CO., LTD., Beijing (CN)

(21) Appl. No.: 18/861,045

(22) PCT Filed: Apr. 29, 2022
(86) PCT No.: PCT/CN2022/090735

§ 371 Date: Oct. 28, 2024

(51) Int. Cl. H04L 5/00; H04W 40/22

(52) U.S. Cl. CPC H04L 5/0078; H04W 40/22

(57) ABSTRACT

A method, apparatus and computer readable medium for transmission timing adjustment in a wireless communication network. The transmission timing adjustment is performed by: determining by a base station a first time offset quantization value, wherein the first time offset quantization value at least represents a time for which a relay device performs uplink and downlink switching; and sending by the base station a timing advance offset (TA-offset) quantization value to a user equipment (UE) according to the first time offset quantization value and a second time offset quantization value, wherein the second time offset quantization value at least represents a time for which the base station performs uplink and downlink switching, and the TA-offset quantization value is used by the UE to adjust transmission timing.

### CROSS-REFERENCE TO RELATED APPLICATION

The present application is a U.S. National Phase of International Patent Application Serial No. PCT/CN2022/090735 filed on Apr. 29, 2022. The contents of this application are hereby incorporated by reference in their entirety for all purposes.

### BACKGROUND OF THE INVENTION

In order to ensure uplink orthogonality, a base station requires that the time at which signals from different user equipment (UEs) in the same subframe but using different frequency domain resources reach the base station is substantially aligned. The base station may correctly decode uplink data upon receiving the uplink data sent by the UEs within the range of a cyclic prefix (CP).

### SUMMARY OF THE INVENTION

In order to overcome the problems existing in the related art, the present disclosure provides a transmission timing adjustment method and apparatus, and a storage medium.

According to a first aspect of an embodiment of the present disclosure, a transmission timing adjustment method is provided, including: determining by a base station a first time offset quantization value, where the first time offset quantization value at least represents a time for which a relay device performs uplink and downlink switching; and sending by the base station a TA-offset quantization value to a UE according to the first time offset quantization value and a second time offset quantization value, where the second time offset quantization value at least represents a time for which the base station performs uplink and downlink switching, and the TA-offset quantization value is used by the UE to adjust transmission timing.

According to a second aspect of an embodiment of the present disclosure, a transmission timing adjustment method is provided, including: reporting by a relay device a first time offset quantization value to a base station, where the first time offset quantization value at least represents a time for which the relay device performs uplink and downlink switching; receiving by the relay device a TA-offset quantization value sent by the base station to a UE, where the TA-offset quantization value is sent by the base station according to the first time offset quantization value and a second time offset quantization value, and the second time offset quantization value at least represents a time for which the base station performs uplink and downlink switching; and relaying by the relay device the TA-offset quantization value to the UE.

According to a third aspect of an embodiment of the present disclosure, a transmission timing adjustment method is provided, including: receiving by a UE a TA-offset quantization value sent by a base station to the UE, where the TA-offset quantization value is sent by the base station according to a first time offset quantization value and a second time offset quantization value, the first time offset quantization value at least represents a time for which a relay device performs uplink and downlink switching, and the second time offset quantization value at least represents a time for which the base station performs uplink and downlink switching; and adjusting by the UE transmission timing according to the TA-offset quantization value.

According to a fourth aspect of an embodiment of the present disclosure, a non-transitory computer-readable storage medium having computer program instructions stored thereon is provided. The program instructions, when executed by one or more processors, implement steps of the transmission timing adjustment method of any one of first to third aspects.

According to a fifth aspect of an embodiment of the present disclosure, a transmission timing adjustment apparatus is provided, and includes: one or more processors; and a memory for storing instructions executable by the one or more processors; where the one or more processors are collectively configured to implement the transmission timing adjustment method of any one of first to third aspects when executing the executable instructions.

It is to be understood that the above general description and the following detailed description are merely illustrative and explanatory, and are not restrictive of the present disclosure.

### BRIEF DESCRIPTION OF DRAWINGS

The above and/or additional aspects and advantages of the present disclosure will become apparent and easily understood from the following description of the embodiments in conjunction with accompanying drawings, in which:

FIG. 1 is a schematic diagram showing an application scenario of a transmission timing adjustment method according to an example embodiment.

FIG. 2 is a schematic flowchart showing a transmission timing adjustment method according to an example embodiment.

FIG. 3 is a schematic flowchart showing a transmission timing adjustment method according to an example embodiment.

FIG. 4 is a schematic flowchart showing a transmission timing adjustment method according to an example embodiment.

FIG. 5 is a schematic flowchart showing a transmission timing adjustment method according to an example embodiment.

FIG. 6 is a schematic flowchart showing a transmission timing adjustment method according to an example embodiment.

FIG. 7 is a schematic flowchart showing a transmission timing adjustment method according to an example embodiment.

FIG. 8 is a schematic flowchart showing a transmission timing adjustment method according to an example embodiment.

FIG. 9 is a schematic flowchart showing a transmission timing adjustment method according to an example embodiment.

FIG. 10 is a schematic flowchart showing a transmission timing adjustment method according to an example embodiment.

FIG. 11 is a schematic flowchart showing a transmission timing adjustment method according to an example embodiment.

FIG. 12 is a schematic flowchart showing a transmission timing adjustment method according to an example embodiment.

FIG. 13 is a schematic flowchart showing a transmission timing adjustment method according to an example embodiment.

FIG. 14 is a schematic flowchart showing a transmission timing adjustment method according to an example embodiment.

FIG. 15 is a schematic flowchart showing a transmission timing adjustment method according to an example embodiment.

FIG. 16 is a schematic flowchart showing a transmission timing adjustment method according to an example embodiment.

FIG. 17 is a structural block diagram showing a transmission timing adjustment apparatus according to an example embodiment.

FIG. 18 is a structural block diagram showing a transmission timing adjustment apparatus according to an example embodiment.

FIG. 19 is a structural block diagram showing a transmission timing adjustment apparatus according to an example embodiment.

FIG. 20 is a structural block diagram showing a transmission timing adjustment apparatus according to an example embodiment.

FIG. 21 is a structural block diagram showing a transmission timing adjustment apparatus according to an example embodiment.

### DETAILED DESCRIPTION OF THE INVENTION

Example embodiments will be described, examples of which are represented in accompanying drawings. When the following description refers to accompanying drawings, unless otherwise indicated, the same numbers in different accompanying drawings represent the same or similar elements. The implementations described in the following example embodiments do not represent all implementations consistent with the present disclosure, and on the contrary, are merely examples of apparatuses and methods consistent with some aspects of the present disclosure, as detailed in the appended claims.

The present disclosure relates to the technical field of wireless communications, and in particular, to a transmission timing adjustment method and apparatus, and a storage medium.

In order to ensure uplink orthogonality, a base station requires that the time at which signals from different UEs in the same subframe but using different frequency domain resources reach the base station is substantially aligned. The base station may correctly decode uplink data upon receiving the uplink data sent by the UEs within the range of a CP. Therefore, in an uplink synchronization mechanism of the related art, the base station adjusts uplink transmission timing by indicating a timing advance (TA) quantization value and a timing advance offset (TA-offset) quantization value to the UEs, so that the time at which the signals from different UEs in the same subframe reach the base station falls within the range of CP.

With the development of communication technology, a network-controlled relay device is expected to be a key technology for expanding a cell coverage. The signals sent by the UEs or the base station are relayed through the relay device, which may effectively expand the cell coverage. However, when the signals are relayed by the relay device, an uplink synchronization mechanism in the related art will be affected.

It is to be noted that all actions for acquiring signals, information or data in the present disclosure are carried out in accordance with relevant data protection laws and policies of the country where they are located and with the authorization from the owner of the corresponding apparatus.

FIG. 1 is a schematic diagram showing a wireless communication system 100 according to an example embodiment. As shown in FIG. 1, the wireless communication system 100 includes several UEs 11, a relay device 12, and a base station 13.

The UEs 11 may refer to devices that provide voice and/or data connectivity to users. The UEs 11 may communicate with one or more core networks via a radio access network (RAN). The UEs 11 may be internet of things (IoT) terminals, such as sensor devices, mobile phones (or “cellular” phone), and computers with an IoT terminal, and for example, may be fixed, portable, pocket, handheld, computer-built-in, or vehicle-mounted apparatuses such as stations (STAs), subscriber units, subscriber stations, mobile stations, mobiles, remote stations, access points, remote terminals, access terminals, user terminal, user agents, UEs, or user terminals. Alternatively, the UEs 11 may also be devices of unmanned aerial vehicles (UAVs). Alternatively, the UEs 11 may also be vehicle-mounted devices, such as electronic control units (ECUs) with a wireless communication function or wireless communication devices externally connected to the ECUs. Alternatively, the UEs 11 may also be roadside devices, such as street lamps with a wireless communication function, signal lamps, or other roadside devices.

The relay device 12 may include a repeater unit (RU) and a mobile terminal (MT). The MT is configured to receive and process control signals sent by a base station, and has some terminal functions. The RU is configured to relay signals from a base station or a terminal.

An intelligent metasurface, or an intelligent reflection surface (IRS) is also referred to as a “reconfigurable intelligent surface (RIS)” or an “intelligent reflective surface”. From the appearance, the RIS is a common thin sheet, but may be flexibly deployed in a wireless communication propagation environment and achieve manipulation of frequencies, phases, polarization and other features of reflected or refracted electromagnetic waves, thereby reshaping a wireless channel. Specifically, the RIS may reflect signals incident on its surface to a specific direction by using a precoding technology, thereby enhancing a signal strength at a receiving end and achieving control of a channel.

Since an intelligent relay device and the RIS have similar characteristics when interacting in a network, the relay device refers to the intelligent relay device and the RIS in the present disclosure.

The base station 13 may be a network-side device in the wireless communication system 100. The wireless communication system 100 may be a 4th generation mobile communication (4G) system, also referred to as a long term evolution (LTE) system. Alternatively, the wireless communication system 100 may also be a 5G system, also referred to as a new radio (NR) system or a 5G NR system. Alternatively, the wireless communication system 100 may also be a next generation system of the 5G system.

The base station 13 may be an evolved base station (eNB) adopted in the 4G system. Alternatively, the base station 13 may also be a base station (gNB) with a central distributed architecture in the 5G system. When adopting the central distributed architecture, the base station 13 generally includes a central unit (CU) and at least two distributed units (DUs). The central unit includes a protocol stack with a packet data convergence protocol (PDCP) layer, a radio link control (RLC) layer and a media access control (MAC) layer. The distributed units include physical (PHY) layer protocol stacks. The implementation of the base station 13 is not limited in embodiments of the present disclosure.

Each UE 11 may establish a wireless connection with the relay device 12 via a wireless air interface, and the relay device 12 may also establish a communication connection with the base station 13 via a wireless air interface. In different implementations, the wireless air interface is a wireless air interface based on the 4G standard. Alternatively, the wireless air interface is a wireless air interface based on the 5G standard, and for example, the wireless air interface is a new radio air interface. Alternatively, the wireless air interface may also be a wireless air interface based on a next generation mobile communication network standard based on 5G.

Referring to FIG. 1, signals from the UEs 11 are relayed by the relay device 12 before reaching the base station 13. Similarly, signals sent by the base station 13 are relayed by the relay device 12 before reaching the UEs 11. It is worth noting that UEs within the coverage of the same base station may include UEs that perform auxiliary communication via the relay device and devices that perform auxiliary communication not via the relay device. FIG. 1 illustrates UEs 11 that perform auxiliary communication via the relay device.

In the related art, the UEs may calculate transmission timing T_TA based on the following equation:

T_TA=(N_TA+N_TA,offset)*Tc, where N_TA is a TA quantization value sent by the base station to the UEs, N_TA,offset is a timing advance offset quantization value sent by the base station to the UEs, used to represent a time for which the base station performs uplink and downlink switching i.e. a time required for switching to downlink transmission after uplink reception, and Tc is a predefined time unit that represents a minimum sampling interval in NR.

However, when the UEs communicate with the base station via the relay device, it takes a certain time for the relay device to perform uplink and downlink switching, in which case, determining transmission timing of the UEs using the related art may result in failure to achieve uplink and downlink synchronization between the UEs and the base station.

In order to solve the above problems, the embodiments of the present disclosure provide a transmission timing adjustment method and apparatus, and a storage medium.

FIG. 2 is a flowchart showing a transmission timing adjustment method according to an example embodiment. As shown in FIG. 2, the transmission timing adjustment method includes steps S201 and S202.

At S201, a base station determines a first time offset quantization value.

The first time offset quantization value at least represents a time for which a relay device performs uplink and downlink switching.

At S202, the base station sends a TA-offset quantization value to UEs according to the first time offset quantization value and a second time offset quantization value.

The second time offset quantization value at least represents a time for which the base station performs uplink and downlink switching, and the TA-offset quantization value is used by the UEs to adjust transmission timing.

In one embodiment, for uplink and downlink switching of the relay device, the relay device includes two links, where a first link switches from receiving to transmitting, and a second link switches from transmitting to receiving. Therefore, the first time offset quantization value may include a time for which the first link of the relay device switches from receiving to transmitting, and a time for which the second link switches from transmitting to receiving. Likewise, the second time offset quantization value may also include a time for which the first link of the base station switches from receiving to transmitting, and a time for which the second link switches from transmitting to receiving.

In one embodiment, the UEs included in the signal coverage of the base station may include a UE that directly provides services (i.e., signaling is relayed between the UE and the base station not via the relay device), also referred to as a second UE in other embodiments below, and the second UE includes an MT part of the relay device. In this case, in calculation of the transmission timing of the second UE, merely uplink and downlink switching time of the base station needs to be considered for the TA-offset quantization value, for example, the transmission timing may be calculated by merely using the second time offset quantization value.

In one embodiment, the UEs included in the signal coverage of the base station may also include a UE that indirectly provides services (i.e., signaling is relayed between the UE and the base station not via the relay device), also referred to as a first UE in other embodiments. In this case, in calculation of the transmission timing of the first UE, the uplink and downlink switching time of the base station and the uplink and downlink switching time of the relay device may be considered simultaneously for the TA-offset quantization value, for example, the transmission timing may be calculated by using the first time offset quantization value and the second time offset quantization value.

Using the above method, the base station determines the first time offset quantization value that at least represents the time for which the relay device performs uplink and downlink switching, and sends the TA-offset quantization value to the UEs according to the first time offset quantization value and the second time offset quantization value that at least represents the time for which the base station performs uplink and downlink switching. In this way, the UEs adjust transmission timing according to the TA-offset quantization value received, and may add the time for which the relay device performs uplink and downlink switching to calculation of uplink timing advance of communication between the base station and the UEs, so that a time at which uplink signals of different UEs reach the base station can be more accurately aligned.

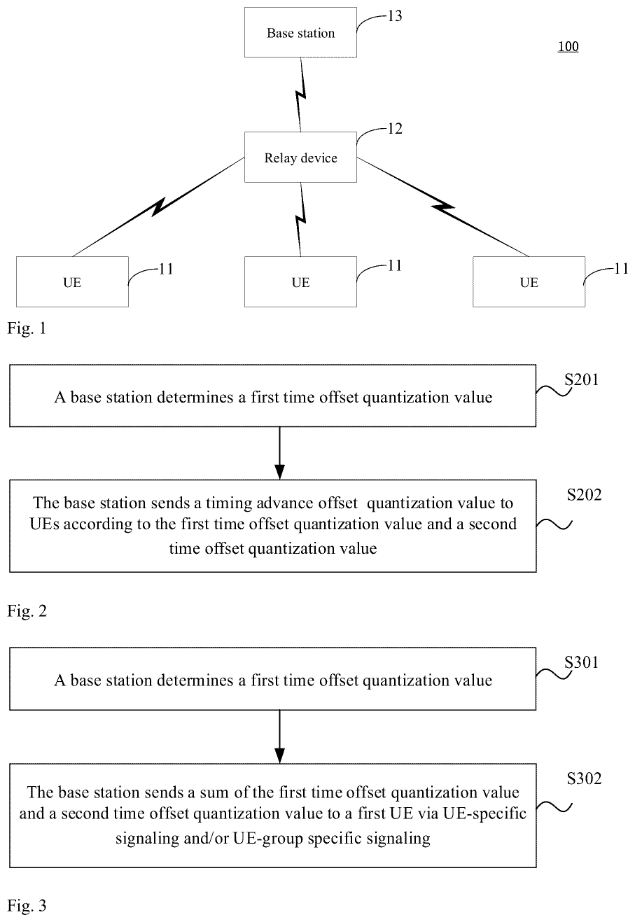

FIG. 3 is a flowchart showing a transmission timing adjustment method according to an example embodiment. As shown in FIG. 3, the transmission timing adjustment method includes steps S301 and S302.

At S301, a base station determines a first time offset quantization value.

The first time offset quantization value at least represents a time for which a relay device performs uplink and downlink switching.

At S302, the base station sends a sum of the first time offset quantization value and a second time offset quantization value to a first UE via UE-specific signaling and/or UE-group specific signaling.

UEs within the coverage of the base station includes a first UE that performs auxiliary communication via the relay device.

In one embodiment, the TA-offset quantization value may be the sum of the first time offset quantization value and the second time offset quantization value, for example, the sum of the time for which the relay device performs uplink and downlink switching and the time for which the base station performs uplink and downlink switching.

In one embodiment, before the base station sends the sum of the first time offset quantization value and the second time offset quantization value to the first UE via the UE-specific signaling and/or the UE-group specific signaling, it may also be determined that the relay device is transparent to the first UE. The relay device being transparent to the first UE means that the first UE does not perceive whether the communication between the first UE and the base station is relayed through the relay device. In this case, the base station may send the sum of the first time offset quantization value and the second time offset quantization value to the first UE via the UE-specific signaling and/or the UE-group specific signaling. After acquiring the sum included in the UE-specific signaling and/or the UE-group specific signaling, the first UE may adjust transmission timing according to the sum.

Using the above method, the transmission timing may be adjusted according to the received sum of the first time offset quantization value and the second time offset quantization value for the UE that performs auxiliary communication via the relay device, so that the time at which uplink signals of different UEs reach the base station may be more accurately aligned.

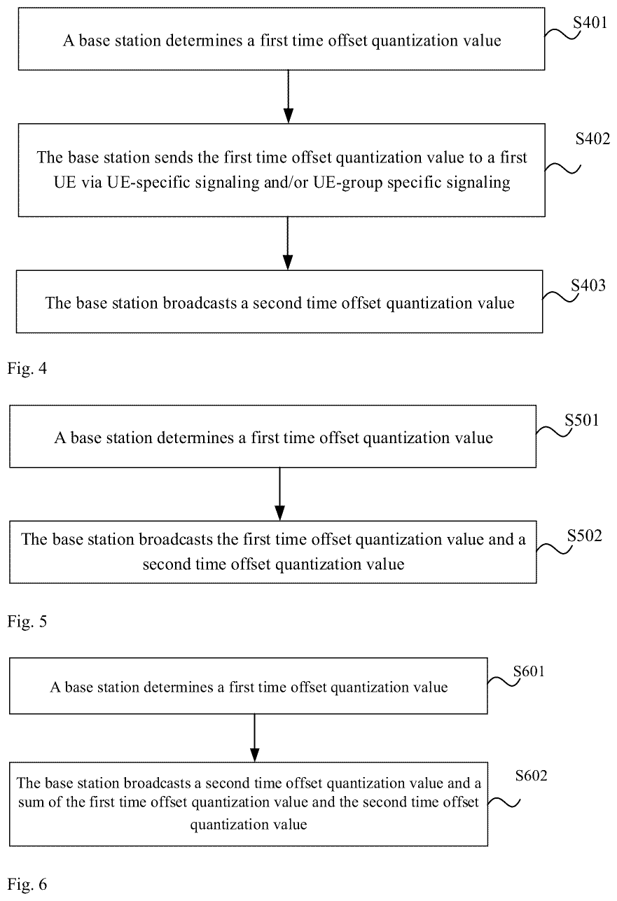

FIG. 4 is a flowchart showing a transmission timing adjustment method according to an example embodiment. As shown in FIG. 4, the transmission timing adjustment method includes steps from S401 to S403.

At S401, a base station determines a first time offset quantization value.

The first time offset quantization value at least represents a time for which a relay device performs uplink and downlink switching.

At S402, the base station sends the first time offset quantization value to a first UE via UE-specific signaling and/or UE-group specific signaling.

The UEs within the coverage of the base station include the first UE and a second UE. The first UE is a UE that performs auxiliary communication via the relay device, and the second UE is a UE that performs auxiliary communication not via the relay device.

At S403, the base station broadcasts a second time offset quantization value.

In one embodiment, the UEs may include a first UE that performs auxiliary communication via the relay device, and may also include a second UE that performs auxiliary communication not via the relay device. In this case, the base station sends the first time offset quantization value to the first UE via the UE-specific signaling and/or the UE-group specific signaling, and broadcasts the second time offset quantization value. The first UE may add the first time offset quantization value on the basis of receiving the broadcast second time offset quantization value, so as to adjust the transmission timing according to the sum of the first time offset quantization value and the second time offset quantization value.

In one embodiment, before the base station sends the first time offset quantization value to the first UE via the UE-specific signaling and/or the UE-group specific signaling, it may also be determined that the relay device is transparent to the first UE. The relay device being transparent to the first UE means that the first UE does not perceive whether the communication between the first UE and the base station is relayed through the relay device. In this case, the base station may send the first time offset quantization value to the first UE via the UE-specific signaling and/or the UE-group specific signaling. After acquiring the first time offset quantization value included in the UE-specific signaling and/or the UE-group specific signaling, the first UE may adjust the transmission timing according to the first time offset quantization value and the second time offset quantization value.

Using this embodiment, when the UEs include, within the coverage of the base station, a second UE that performs auxiliary communication not by using the relay device and a first UE that performs auxiliary communication by using the relay device, the base station may broadcast the second time offset quantization value to all UEs, and send the first time offset quantization value to the first UE via the UE-specific signaling and/or the UE-group specific signaling, so that the second UE merely receives the second time offset quantization value broadcast by the base station, while the first UE may receive the first time offset quantization value and the second time offset quantization value. Then, the second UE may adjust the transmission timing according to the second time offset quantization value, and the first UE may adjust the transmission timing according to the first time offset quantization value and the second time offset quantization value.

FIG. 5 is a flowchart showing a transmission timing adjustment method according to an example embodiment. As shown in FIG. 5, the transmission timing adjustment method includes steps S501 and S502.

At S501, a base station determines a first time offset quantization value.

The first time offset quantization value at least represents a time for which a relay device performs uplink and downlink switching.

At S502, the base station broadcasts the first time offset quantization value and a second time offset quantization value.

In one embodiment, before the base station broadcasts the first time offset quantization value and the second time offset quantization value, it may also be determined that the relay device is not transparent to the first UE. The relay device being not transparent to the first UE means that the first UE may perceive whether the communication between the first UE and the base station is relayed through the relay device.

Using the above method, the UE that performs auxiliary communication via the relay device and the UE that performs auxiliary communication not via the relay device may receive the first time offset quantization value and the second time offset quantization value, so that the UE that performs auxiliary communication via the relay device adjusts the transmission timing according to the first time offset quantization value and the second time offset quantization value, and the UE that performs auxiliary communication not via the relay device adjusts the transmission timing according to the second time offset quantization value.

FIG. 6 is a flowchart showing a transmission timing adjustment method according to an example embodiment. As shown in FIG. 6, the transmission timing adjustment method includes steps S601 and S602.

At S601, a base station determines a first time offset quantization value.

The first time offset quantization value at least represents a time for which a relay device performs uplink and downlink switching.

At S602, the base station broadcasts a second time offset quantization value and a sum of the first time offset quantization value and the second time offset quantization value.

In one embodiment, before the base station broadcasts the first time offset quantization value and the second time offset quantization value, it may also be determined that the relay device is not transparent to the first UE. The relay device being not transparent to the first UE means that the first UE may perceive whether the communication between the first UE and the base station is relayed through the relay device.

Using the above method, after receiving the second time offset quantization value broadcast by the base station and the sum of the first time offset quantization value and the second time offset quantization value, the UE that performs auxiliary communication via the relay device may adjust the transmission timing according to the sum of the first time offset quantization value and the second time offset quantization value. After receiving the second time offset quantization value broadcast by the base station, the UE that performs auxiliary communication not via the relay device may adjust the transmission timing according to the second time offset quantization value.

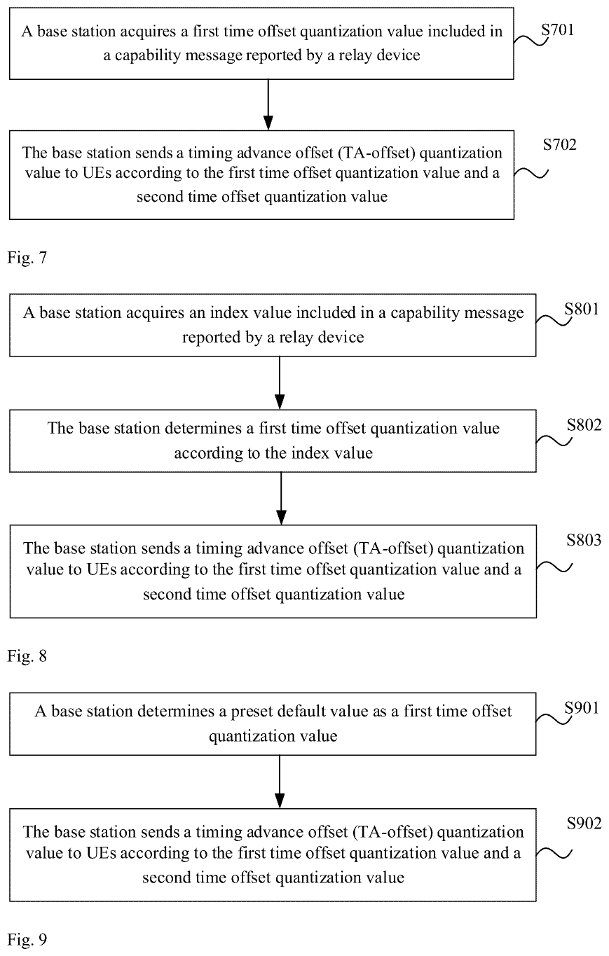

FIG. 7 is a flowchart showing a transmission timing adjustment method according to an example embodiment. As shown in FIG. 7, the transmission timing adjustment method includes steps S701 and S702.

At S701, a base station acquires a first time offset quantization value included in a capability message reported by a relay device.

The first time offset quantization value at least represents a time for which the relay device performs uplink and downlink switching.

At S702, the base station sends a TA-offset quantization value to UEs according to the first time offset quantization value and a second time offset quantization value.

The second time offset quantization value at least represents a time for which the base station performs uplink and downlink switching, and the TA-offset quantization value is used by the UEs to adjust transmission timing.

In one embodiment, the capability message reported by the relay device to the base station includes timing offset quantization values, for example, the first time offset quantization value may be reported in the capability message reported by the relay device, for example, reported in repeater-MT capability.

Using the above method, a more accurate first time offset quantization value may be acquired by acquiring the capability message reported by the relay device.

FIG. 8 is a flowchart showing a transmission timing adjustment method according to an example embodiment. As shown in FIG. 8, the transmission timing adjustment method includes steps from S801 to S803.

At S801, a base station acquires an index value included in a capability message reported by a relay device.

At S802, the base station determines a first time offset quantization value according to the index value.

The first time offset quantization value at least represents a time for which the relay device performs uplink and downlink switching.

At S803, the base station sends a TA-offset quantization value to UEs according to the first time offset quantization value and a second time offset quantization value.

The second time offset quantization value at least represents a time for which the base station performs uplink and downlink switching, and the TA-offset quantization value is used by the UEs to adjust transmission timing.

In one embodiment, the first time offset quantization value may be an index value, such as a capability class index, and different indexes may correspond to different values. The index value is placed in the capability message reported by the relay device.

Using the above method, a more accurate first time offset quantization value may be acquired by acquiring the index value included in the capability message reported by the relay device.

FIG. 9 is a flowchart showing a transmission timing adjustment method according to an example embodiment. As shown in FIG. 9, the transmission timing adjustment method includes steps S901 and S902.

At S901, a base station determines a preset default value as a first time offset quantization value.

The first time offset quantization value at least represents a time for which a relay device performs uplink and downlink switching.

At S902, the base station sends a TA-offset quantization value to UEs according to the first time offset quantization value and a second time offset quantization value.

The second time offset quantization value at least represents a time for which the base station performs uplink and downlink switching, and the TA-offset quantization value is used by the UEs to adjust transmission timing.

In one embodiment, the first time offset quantization value may be a preset default value, such as {FR1,10 us;FR2,8 us}, in which case the relay device does not need to report, and the UEs may directly adjust the transmission timing according to the preset default value.

Using the above method, the UEs may adjust the transmission timing according to the preset default value without the need for the relay device to report, thereby reducing a signaling overhead.

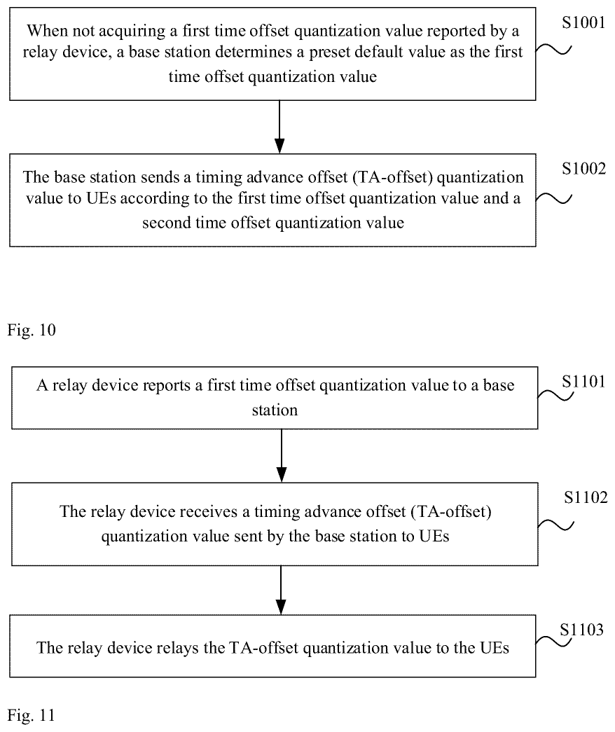

FIG. 10 is a flowchart showing a transmission timing adjustment method according to an example embodiment. As shown in FIG. 10, the transmission timing adjustment method includes steps S1001 and S1002.

At S1001, when not acquiring a first time offset quantization value reported by a relay device, a base station determines a preset default value as the first time offset quantization value.

The first time offset quantization value at least represents a time for which the relay device performs uplink and downlink switching.

At S1002, the base station sends a TA-offset quantization value to UEs according to the first time offset quantization value and a second time offset quantization value.

The second time offset quantization value at least represents a time for which the base station performs uplink and downlink switching, and the TA-offset quantization value is used by the UEs to adjust transmission timing.

In one embodiment, when not acquiring the first time offset quantization value reported by the relay device, the base station may determine the preset default value as the first time offset quantization value, and the UEs adjust the transmission timing according to the preset default value. When the base station acquires the first time offset quantization value reported by the relay device, the UEs adjust the transmission timing according to the acquired first time offset quantization value.

In the transmission timing adjustment method illustrated according to the example embodiment shown in FIG. 1 to FIG. 10, different frequency bands may correspond to different time offset quantization values. Therefore, In one embodiment, the first time offset quantization value may include quantization values corresponding to different frequency bands. For example, the first time offset quantization value may be a set of values, including a plurality of quantization values, and each quantization value corresponds to a different frequency band. For example, the reported content is {FR1,1000;FR2,800}, that is, a quantization value of frequency band FR1 is 1000, and a quantization value of frequency band FR2 is 800.

Furthermore, in another example, the time unit of the first time offset quantization value is an absolute time unit, such as us, ns, etc., or the time unit of the first time offset quantization value is a time unit in a wireless communication system. The time unit in the wireless communication system may be a minimum sampling interval Tc of a physical layer, or other time length of the physical layer, such as symbol, slot, etc. The embodiments of the present disclosure do not limit this.

FIG. 11 is a flowchart showing a transmission timing adjustment method according to an example embodiment. As shown in FIG. 11, the transmission timing adjustment method includes steps from S1101 to S1103.

At S1101, a relay device reports a first time offset quantization value to a base station.

The first time offset quantization value at least represents a time for which the relay device performs uplink and downlink switching.

At S1102, the relay device receives a TA-offset quantization value sent by the base station to UEs.

The base station sends the TA-offset quantization value according to the first time offset quantization value and a second time offset quantization value, and the second time offset quantization value at least represents a time for which the base station performs uplink and downlink switching.

At S1103, the relay device relays the TA-offset quantization value to the UEs.

Using the above method, the relay device reports to the base station the first time offset quantization value that represents the time for which the relay device performs uplink and downlink switching, receives the TA-offset quantization value sent by the base station to the UEs, and then relays the TA-offset quantization value to the UEs. In this way, the UEs adjust the transmission timing according to the received TA-offset quantization value, and may add the time for which the relay device performs uplink and downlink switching to the calculation of uplink timing advance of the communication between the base station and the UEs, so that the time at which uplink signals of different UEs reach the base station may be more accurately aligned.

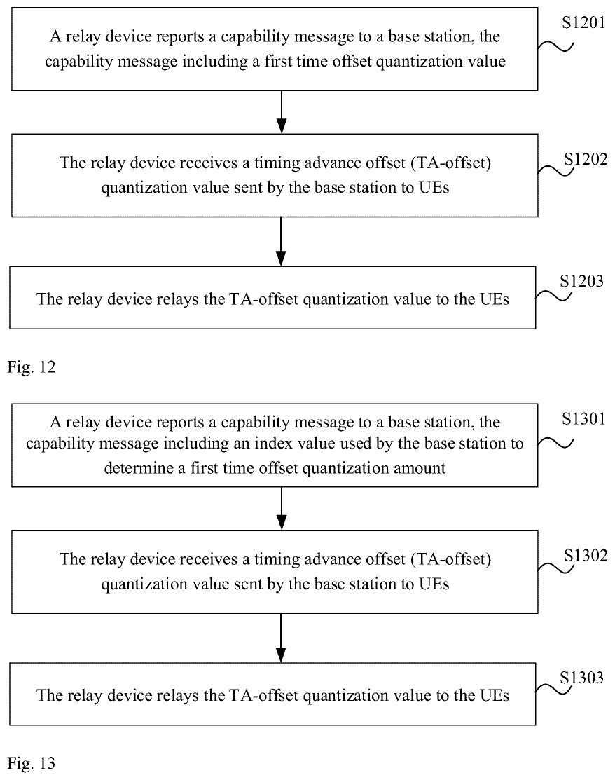

FIG. 12 is a flowchart showing a transmission timing adjustment method according to an example embodiment. As shown in FIG. 12, the transmission timing adjustment method includes steps from S1201 to S1203.

At S1201, a relay device reports a capability message to a base station, the capability message including a first time offset quantization value.

The first time offset quantization value at least represents a time for which the relay device performs uplink and downlink switching.

At S1202, the relay device receives a TA-offset quantization value sent by the base station to UEs.

The TA-offset quantization value is sent by the base station according to the first time offset quantization value and a second time offset quantization value, and the second time offset quantization value at least represents a time for which the base station performs uplink and downlink switching.

At S1203, the relay device relays the TA-offset quantization value to the UEs.

In one embodiment, the capability message may include the first time offset quantization value. The relay device reports the capability message to the base station, and the base station may determine the first time offset quantization value after receiving the capability message.

Using the above method, the first time offset quantization value is placed in the capability message, and the relay device may report the first time offset quantization value by reporting the capability message to the base station.

FIG. 13 is a flowchart showing a transmission timing adjustment method according to an example embodiment. As shown in FIG. 13, the transmission timing adjustment method includes steps from S1301 to S1303.

At S1301, a relay device reports a capability message to a base station, the capability message including an index value used by the base station to determine a first time offset quantization value.

The first time offset quantization value at least represents a time for which the relay device performs uplink and downlink switching.

At S1302, the relay device receives a TA-offset quantization value sent by the base station to UEs.

The TA-offset quantization value is sent by the base station according to the first time offset quantization value and a second time offset quantization value. The second time offset quantization value at least represents a time for which the base station performs uplink and downlink switching.

S1303. The relay device relays the TA-offset quantization value to the UEs.

In one embodiment, the capability message may include an index value used by the base station to determine a first time offset quantization value.

Using the above method, the first time offset quantization value is placed in the capability message according to the index value, and the relay device may report the first time offset quantization value by reporting the capability message to the base station.

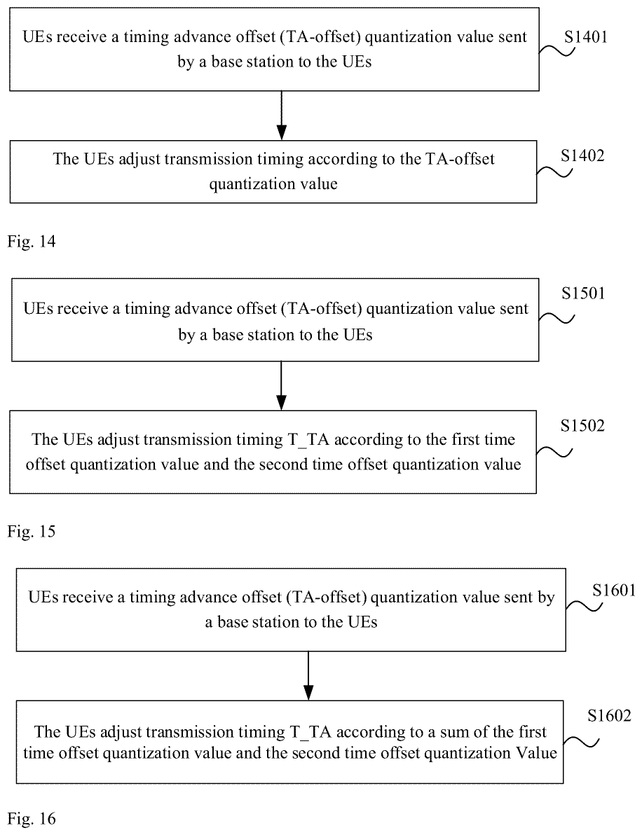

FIG. 14 is a flowchart showing a transmission timing adjustment method according to an example embodiment. As shown in FIG. 14, the transmission timing adjustment method includes steps S1401 and S1402.

At S1401, UEs receive a TA-offset quantization value sent by a base station to the UEs.

The TA-offset quantization value is sent by the base station according to a first time offset quantization value and a second time offset quantization value. The first time offset quantization value at least represents a time for which a relay device performs uplink and downlink switching, and the second time offset quantization value at least represents a time for which the base station performs uplink and downlink switching.

At S1402, the UEs adjust transmission timing according to the TA-offset quantization value.

Using the above method, the UEs adjust the transmission timing according to the received TA-offset quantization value, and may add the time for which the relay device performs uplink and downlink switching to calculation of the transmission timing (also referred to as uplink timing advance), so that the time at which uplink signals of different UEs reach the base station may be more accurately aligned.

FIG. 15 is a flowchart showing a transmission timing adjustment method according to an example embodiment. As shown in FIG. 15, the transmission timing adjustment method includes steps S1501 and S1502.

At S1501, UEs receive a TA-offset quantization value sent by a base station to the UEs.

The TA-offset quantization value is sent by the base station according to a first time offset quantization value and a second time offset quantization value. The first time offset quantization value at least represents a time for which a relay device performs uplink and downlink switching, and the second time offset quantization value at least represents a time for which the base station performs uplink and downlink switching.

The UEs perform auxiliary communication via the relay device. The TA-offset quantization value includes the first time offset quantization value and the second time offset quantization value.

At S1502, the UEs adjust transmission timing T_TA according to the first time offset quantization value and the second time offset quantization value.

T_TA=(N_TA+N_TA,offset1+N_TA,offset2)*Tc, where N_TA is a TA quantization value sent by the base station, N_TA,offset1 is the first time offset quantization value, N_TA,offset2 is the second time offset quantization value, and Tc is a predefined time unit.

In one embodiment, the UEs acquire a second time offset from a broadcast of the base station, and acquire the first time offset quantization value from UE-specific signaling and/or UE-group specific signaling sent by the base station. In this way, after receiving the signaling, the UEs may add the first time offset quantization value and the second time offset quantization value on the basis of the TA quantization value sent by the base station to adjust the transmission timing.

Using the above method, the UEs may add the time for which the relay device performs uplink and downlink switching to calculation of the transmission timing, so that the time at which uplink signals of different UEs reach the base station may be more accurately aligned.

FIG. 16 is a flowchart showing a transmission timing adjustment method according to an example embodiment. As shown in FIG. 16, UEs perform auxiliary communication via a relay device, a TA-offset quantization value includes a sum of a first time offset quantization value and a second time offset quantization value, and the UEs adjust transmission timing according to the TA-offset quantization value. The transmission timing adjustment method includes steps S1601 and S1602.

At S1601, the UEs receive a TA-offset quantization value sent by a base station to the UEs.

The TA-offset quantization value is sent by the base station according to the first time offset quantization value and the second time offset quantization value. The first time offset quantization value at least represents a time for which a relay device performs uplink and downlink switching, and the second time offset quantization value at least represents a time for which the base station performs uplink and downlink switching.

At S1602, the UEs adjust transmission timing T_TA according to the sum of the first time offset quantization value and the second time offset quantization value. T_TA=(N_TA+N_TA,offset1′)*Tc, where N_TA is a TA quantization value sent by the base station, TA,offset1′ is the sum of the first time offset quantization value and the second time offset quantization value, and Tc is a predefined time unit.

In one embodiment, the UEs acquire the second time offset from a broadcast of the base station, and acquire the sum of the first time offset quantization value and the second time offset quantization value from the UE-specific signaling and/or the UE-group specific signaling sent by the base station. In this way, after receiving the signaling, the UEs may add the first time offset quantization value and the second time offset quantization value on the basis of the TA quantization value sent by the base station to adjust the transmission timing.

Using the above method, the UEs may add the time for which the relay device performs uplink and downlink switching to calculation of transmission timing, so that the time at which uplink signals of different UEs reach the base station may be more accurately aligned.

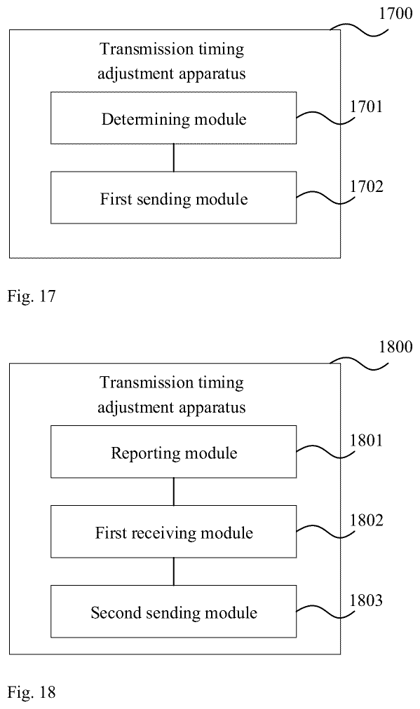

FIG. 17 is a structural block diagram showing a transmission timing adjustment apparatus according to an example embodiment. The transmission timing adjustment apparatus may be a base station or a part of a base station implemented by software, hardware, or a combination of software and hardware, and is configured to execute steps of the transmission timing adjustment method provided in the aforementioned base station side method embodiments. Referring to FIG. 17, the transmission timing adjustment apparatus 1700 includes a determining module 1701 and a first sending module 1702.

The determining module 1701 is configured to determine a first time offset quantization value.

The first sending module 1702 is configured to send a TA-offset quantization value to UEs according to the first time offset quantization value and a second time offset quantization value.

Optionally, the UEs include a first UE, which is a UE that performs auxiliary communication via the relay device. The first sending module 1702 includes:

a first sending submodule, configured to send a sum of the first time offset quantization value and the second time offset quantization value to the first UE via UE-specific signaling and/or UE-group specific signaling.

Optionally, the UEs include a first UE and a second UE. The first UE is a UE that performs auxiliary communication via a relay device, and the second UE is a UE that performs auxiliary communication not via the relay device. The first sending module 1702 includes:

a second sending submodule, configured to send the first time offset quantization value to the first UE via UE-specific signaling and/or UE-group specific signaling.; and

a first broadcast module, configured to broadcast the second time offset quantization value.

Optionally, the apparatus also includes:

a first determining submodule, configured to, before sending a TA-offset quantization value to the UEs according to the first time offset quantization value and the second time offset quantization value, determine that the relay device is transparent to the first UE.

Optionally, the first sending module 1702 includes:

a second broadcast module, configured to broadcast the first time offset quantization value and the second time offset quantization value.

Optionally, the first sending module 1702 includes:

a third broadcast module, configured to broadcast the second time offset quantization value and a sum of the first time offset quantization value and the second time offset quantization value.

Optionally, the UEs include a first UE, which is a UE that performs auxiliary communication via the relay device. The apparatus also includes:

a second determining submodule, configured to, before sending a TA-offset quantization value to the UEs according to the first time offset quantization value and the second time offset quantization value, determine that the relay device is not transparent to the first UE.

Optionally, the determining module 1701 includes:

a first acquiring module, configured to acquire the first time offset quantization value included in a capability message reported by the relay device.

Optionally, the determining module 1701 includes:

a second acquiring module, configured to acquire an index value included in a capability message reported by the relay device; and

a third determining submodule, configured to determine the first time offset quantization value according to the index value.

Optionally, the determining module 1701 includes:

a fourth determining submodule, configured to determine a preset default value as the first time offset quantization value.

Optionally, the determining module 1701 includes:

a fifth determining submodule, configured to, when not acquiring the first time offset quantization value reported by the relay device, determine a preset default value as the first time offset quantization value.

Optionally, the first time offset quantization value includes quantization values corresponding to different frequency bands.

Optionally, the time unit of the first time offset quantization value is an absolute time unit, or the time unit of the first time offset quantization value is a time unit in a wireless communication system.

FIG. 18 is a structural block diagram showing a transmission timing adjustment apparatus according to an example embodiment. The transmission timing adjustment apparatus may be a relay device or a part of a relay device implemented by software, hardware, or a combination of software and hardware, and is configured to execute steps of the transmission timing adjustment method provided in the aforementioned method embodiments on the relay device side. Referring to FIG. 18, the transmission timing adjustment apparatus 1800 includes a reporting module 1801, a first receiving module 1802, and a second sending module 1803.

The reporting module 1801 is configured to report a first time offset quantization value to a base station. The first time offset quantization value at least represents a time for which the relay device performs uplink and downlink switching.

The first receiving module 1802 is configured to receive a TA-offset quantization value sent by the base station to UEs. The TA-offset quantization value is sent by the base station according to the first time offset quantization value and a second time offset quantization value, and the second time offset quantization value at least represents a time for which the base station performs uplink and downlink switching.

The second sending module 1803 is configured to relay the TA-offset quantization value to the UEs.

Optionally, the reporting module 1801 includes:

a first reporting submodule, configured to report a capability message to the base station. The capability message includes the first time offset quantization value.

Optionally, the reporting module 1801 includes:

a second reporting submodule, configured to report a capability message to the base station. The capability message includes an index value used by the base station to determine a first time offset quantization value.

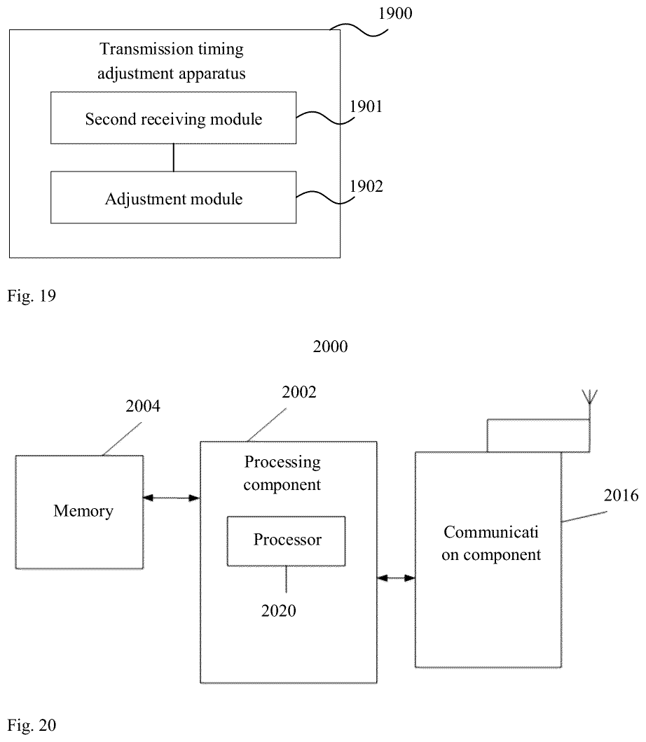

FIG. 19 is a structural block diagram showing a transmission timing adjustment apparatus according to an example embodiment. The transmission timing adjustment apparatus may be a UE or a part of a UE implemented by software, hardware, or a combination of software and hardware, and is configured to execute the steps of the transmission timing adjustment method provided in the aforementioned method embodiments on the UE side. Referring to FIG. 19, the transmission timing adjustment apparatus 1900 includes a second receiving module 1901 and an adjustment module 1902.

The second receiving module 1901 is configured to receive a TA-offset quantization value sent by a base station to UEs. The TA-offset quantization value is sent by the base station according to a first time offset quantization value and a second time offset quantization value. The first time offset quantization value at least represents a time for which a relay device performs uplink and downlink switching, and the second time offset quantization value at least represents a time for which the base station performs uplink and downlink switching.

The adjustment module 1902 is configured to adjust transmission timing according to the TA-offset quantization value.

Optionally, the UEs perform auxiliary communication via the relay device, and the TA-offset quantization value includes the first time offset quantization value and the second time offset quantization value. The adjustment module 1902 includes:

a first adjustment submodule, configured to adjust transmission timing T_TA according to the first time offset quantization value and the second time offset quantization value, where

$$T\_TA = ( N\_TA + N\_TA , offset 1 + N\_TA , offset 2 ) * Tc ;$$

where N_TA is a TA quantization value sent by the base station, N_TA,offset1 is the first time offset quantization value, N_TA,offset2 is the second time offset quantization value, and Tc is a predefined time unit.

Optionally, the UEs perform auxiliary communication via the relay device, and the TA-offset quantization value includes a sum of the first time offset quantization value and the second time offset quantization value. The adjustment module 1902 includes:

a second adjustment submodule, configured to adjust transmission timing T_TA according to the first time offset quantization value and the sum, where

$$T\_TA = ( N\_TA + N\_TA , offset {1}^{′} ) * Tc ;$$

where N_TA is a TA quantization value sent by the base station, TA,offset1′ is the sum of the first time offset quantization value and the second time offset quantization value, and Tc is a predefined time unit.

With respect to the apparatuses in the above embodiments, the specific manner in which each module performs operations has been described in the embodiments of the methods, and will not be elaborated here.

An embodiment of the present disclosure also provides a computer-readable storage medium having computer program instructions stored thereon. When the program instructions are executed by one or more processors, steps of the transmission timing adjustment method performed by any of the base station side, the relay device side, and the UE side provided in the present disclosure are implemented.

An embodiment of the present disclosure also provides a transmission timing adjustment apparatus, including: one or more processors; and a memory for storing instructions executable by the one or more processors. The one or more processors are collectively configured to implement the steps of the transmission timing adjustment method performed by any of the base station side, the relay device side, and the UE side provided in the present disclosure when executing the executable instructions.

FIG. 20 is a structural block diagram showing a transmission timing adjustment apparatus according to an example embodiment. For example, the transmission timing adjustment apparatus 2000 may be the above UE or relay device.

Referring to FIG. 20, the transmission timing adjustment apparatus 2000 may include one or more of a processing component 2002, a memory 2004, and a communication component 2016.

The processing component 2002 generally controls the overall operation of the transmission timing adjustment apparatus 2000, such as operations associated with display, telephone calls, data communications, camera operations, and recording operations. The processing component 2002 may include one or more processors 2020 to execute instructions so as to complete the steps of the method executed on the UE side or the relay device side. In addition, the processing component 2002 may include one or more modules to facilitate the interaction between the processing component 2002 and other components. For example, the processing component 2002 may include a multimedia module to facilitate interaction between a multimedia component 2008 and the processing component 2002.

The memory 2004 is configured to store various types of data to support operations in the transmission timing adjustment apparatus 2000. Examples of such data include instructions for any application or method operating on the transmission timing adjustment apparatus 2000, contact data, phone book data, messages, pictures, videos, etc. The memory 2004 may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic storage, a flash memory, a magnetic disk, or an optical disk.

The communication component 2016 is configured to facilitate wired or wireless communications between the transmission timing adjustment apparatus 2000 and other devices. The transmission timing adjustment apparatus 2000 may access a wireless network based on a communication standard, such as WiFi, 2G or 3G, or a combination thereof. In one embodiment, the communication component 2016 receives a broadcast signal or broadcast-related information from an external broadcast management system via a broadcast channel. In one embodiment, the communication component 2016 also includes a near field communication (NFC) module to facilitate short-range communications. For example, the NFC module may be implemented based on radio frequency identification (RFID) technology, infrared data association (IrDA) technology, ultra wideband (UWB) technology, Bluetooth (BT) technology, and other technologies.

In one embodiment, the transmission timing adjustment apparatus 2000 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to execute the steps of the above method executed on the UE side or the relay device side.

In one embodiment, a non-transitory computer-readable storage medium including instructions is also provided, such as a memory 2004 including instructions, and the above instructions may be executed by the processor 2020 of the transmission timing adjustment apparatus 2000 to complete the above AI service execution method. For example, the non-transitory computer-readable storage medium may be a ROM, a random access memory (RAM), a CD-ROM, a magnetic tape, a floppy disk, an optical data storage device, etc.

In addition to being an independent electronic device, the above device may also be a part of an independent electronic device. For example, in an embodiment, the device may be an integrated circuit (IC) or a chip. The integrated circuit may be one IC or a collection of a plurality of ICs. The chip may include, but is not limited to a graphics processing unit (GPU), a central processing unit (CPU), a field programmable gate array (FPGA), a digital signal processor (DSP), an application specific integrated circuit (ASIC) and a system on chip (SoC). The above integrated circuit or chip may be used to execute executable instructions (or codes) to implement all or part of the steps of the method executed on the above UE side or the relay device side. The executable instructions may be stored in the integrated circuit or chip, or may be acquired from other apparatuses or devices. For example, the integrated circuit or chip includes a processor, a memory, and an interface for communicating with other devices. The executable instructions may be stored in the processor. When the executable instructions are executed by the processor, the steps of the method executed on the UE side or the relay device side are implemented. Alternatively, the integrated circuit or chip may receive the executable instructions via the interface and transmit same to the processor for execution, so as to implement the steps of the method executed on the UE side or the relay device side.

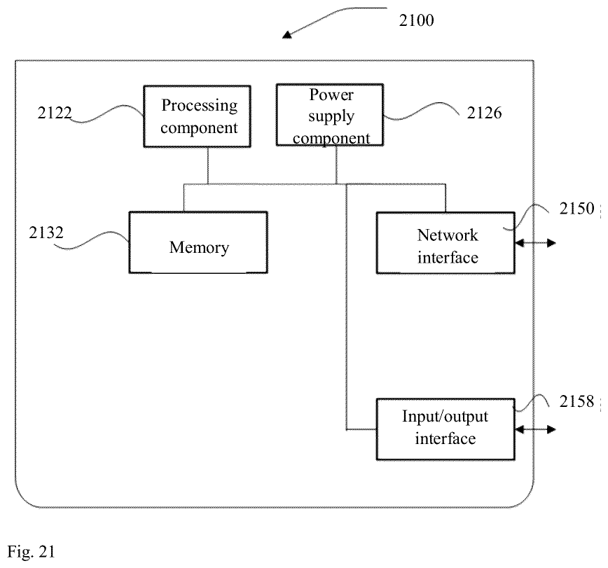

FIG. 21 is a structural block diagram showing a transmission timing adjustment apparatus according to an example embodiment. For example, the transmission timing adjustment apparatus 2100 may be provided as a base station. Referring to FIG. 21, the transmission timing adjustment apparatus 2100 includes a processing component 2122 which further includes one or more processors, and a memory resource represented by a memory 2132 for storing instructions executable by the processing component 2122, such as an application. The application stored in the memory 2132 may include one or more modules, each of which corresponds to a set of instructions. In addition, the processing component 2122 is configured to execute instructions to perform the steps of the transmission timing adjustment method provided in the above method embodiments on the base station side.

The transmission timing adjustment apparatus 2100 may also include a power supply component 2126 configured to perform power supply management of the device 2100, a wired or wireless network interface 2150 configured to connect the transmission timing adjustment apparatus 2100 to the network, and an input/output (I/O) interface 2158. The transmission timing adjustment apparatus 2100 may operate based on an operating system stored in the memory 2132, such as Windows Server™, Mac OS X™, Unix™, Linux™, FreeBSD™, or the like.

In another example embodiment, a computer program product is also provided, including a computer program executable by a programmable device. The computer program has a code portion for executing a transmission timing adjustment method performed by any of a base station side, a relay device side, and a UE side when executed by the programmable device.

According to a first aspect of an embodiment of the present disclosure, a transmission timing adjustment method is provided, including:

determining by a base station a first time offset quantization value, where the first time offset quantization value at least represents a time for which a relay device performs uplink and downlink switching; and

sending by the base station a TA-offset quantization value to a UE according to the first time offset quantization value and a second time offset quantization value, where the second time offset quantization value at least represents a time for which the base station performs uplink and downlink switching, and the TA-offset quantization value is used by the UE to adjust transmission timing.

According to a second aspect of an embodiment of the present disclosure, a transmission timing adjustment method is provided, including:

reporting by a relay device a first time offset quantization value to a base station, where the first time offset quantization value at least represents a time for which the relay device performs uplink and downlink switching;

receiving by the relay device a TA-offset quantization value sent by the base station to a UE, where the TA-offset quantization value is sent by the base station according to the first time offset quantization value and a second time offset quantization value, and the second time offset quantization value at least represents a time for which the base station performs uplink and downlink switching; and

relaying by the relay device the TA-offset quantization value to the UE.

According to a third aspect of an embodiment of the present disclosure, a transmission timing adjustment method is provided, including:

receiving by a UE a TA-offset quantization value sent by a base station to the UE, where the TA-offset quantization value is sent by the base station according to a first time offset quantization value and a second time offset quantization value, the first time offset quantization value at least represents a time for which a relay device performs uplink and downlink switching, and the second time offset quantization value at least represents a time for which the base station performs uplink and downlink switching; and

adjusting by the UE transmission timing according to the TA-offset quantization value.

According to a fourth aspect of an embodiment of the present disclosure, a

transmission timing adjustment apparatus is provided. The transmission timing adjustment apparatus is performed by a base station, and includes:

a determining module, configured to determine a first time offset quantization value, where the first time offset quantization value at least represents a time for which a relay device performs uplink and downlink switching; and

a first sending module, configured to send a TA-offset quantization value to a UE according to the first time offset quantization value and a second time offset quantization value, where the second time offset quantization value at least represents a time for which the base station performs uplink and downlink switching, and the TA-offset quantization value is used by the UE to adjust transmission timing.

According to a fifth aspect of an embodiment of the present disclosure, a transmission timing adjustment apparatus is provided. The transmission timing adjustment apparatus is performed by a relay device, and includes:

a reporting module, configured to report a first time offset quantization value to a base station, where the first time offset quantization value at least represents a time for which the relay device performs uplink and downlink switching;

a first receiving module, configured to receive a TA-offset quantization value sent by the base station to a UE, where the TA-offset quantization value is sent by the base station according to the first time offset quantization value and a second time offset quantization value, and the second time offset quantization value at least represents a time for which the base station performs uplink and downlink switching; and

a second sending module, configured to relay the TA-offset quantization value to the UE.

According to a sixth aspect of an embodiment of the present disclosure, a transmission timing adjustment apparatus is provided. The transmission timing adjustment apparatus is performed by a UE, and includes:

a second receiving module, configured to receive a TA-offset quantization value sent by a base station to the UE, where the TA-offset quantization value is sent by the base station according to a first time offset quantization value and a second time offset quantization value, the first time offset quantization value at least represents a time for which a relay device performs uplink and downlink switching, and the second time offset quantization value at least represents a time for which the base station performs uplink and downlink switching; and

an adjustment module, configured to adjust transmission timing according to the TA-offset quantization value.

According to a seventh aspect of an embodiment of the present disclosure, a computer-readable storage medium having computer program instructions stored thereon is provided. The program instructions, when executed by one or more processors, implement steps of the transmission timing adjustment method of any one of first to third aspects.

According to an eighth aspect of an embodiment of the present disclosure, a transmission timing adjustment apparatus is provided, and includes:

one or more processors; and

a memory for storing instructions executable by the processor;

where the processor is configured to implement the transmission timing adjustment method of any one of first to third aspects when executing the executable instructions.

In the technical solution provided in the embodiments of the present disclosure, the relay device reports to the base station the first time offset quantization value that at least represents the time for which the relay device performs uplink and downlink switching, the base station sends the TA-offset quantization value to the UE according to the first time offset quantization value and the second time offset quantization value that at least represents the time for which the base station performs uplink and downlink switching, and then the relay device relays the TA-offset quantization value to the UE, and the UE adjusts transmission timing according to the received TA-offset quantization value. In this way, in scenarios of communication via the relay device, the time for which the relay device performs uplink and downlink switching may be added to calculation of uplink timing advance of communication between the base station and the UE, so that the time at which uplink signals of different UEs reach the base station can be aligned more accurately.

Other embodiments of the present disclosure will be readily conceivable to those skilled in the art from consideration of the specification and practice of the present disclosure. This application is intended to cover any modifications, uses or adaptations of the present disclosure, which follow the general principles of the present disclosure and include common knowledge or customary technical means in the technical field not disclosed in the present disclosure. It is intended that the specification and embodiments are considered as exemplary merely, with the true scope and spirit of the present disclosure being indicated by the following claims.

It is to be understood that the present disclosure is not limited to a precise structure that has been described above and shown in the accompanying drawings, and that various modifications and changes may be made without departing from the scope thereof. The scope of the present disclosure is merely limited by the appended claims.

1. A method for transmission timing adjustment, comprising:
determining by a base station a first time offset quantization value, wherein the first time offset quantization value at least represents a time for which a relay device performs uplink and downlink switching; and
sending by the base station a timing advance offset (TA-offset) quantization value to a user equipment (UE) according to the first time offset quantization value and a second time offset quantization value, wherein the second time offset quantization value at least represents a time for which the base station performs uplink and downlink switching, and the TA-offset quantization value is used by the UE to adjust transmission timing.

2. The method according to claim 1, wherein the UE comprises a first UE, and the first UE is a UE that performs auxiliary communication via the relay device, wherein sending by the base station the TA-offset quantization value to the UE according to the first time offset quantization value and the second time offset quantization value comprises:
sending by the base station a sum of the first time offset quantization value and the second time offset quantization value to the first UE via UE-specific signaling and/or UE-group specific signaling.

3. The method according to claim 1, wherein the UE comprises a first UE and a second UE, the first UE is a UE that performs auxiliary communication via the relay device, and the second UE is a UE that performs auxiliary communication not via the relay device, wherein sending by the base station the TA-offset quantization value to the UE according to the first time offset quantization value and the second time offset quantization value comprises:
sending by the base station the first time offset quantization value to the first UE via a UE-specific signaling and/or a UE-group specific signaling; and
broadcasting by the base station the second time offset quantization value.

4. The method according to claim 2, wherein, before sending by the base station the TA-offset quantization value to the UE according to the first time offset quantization value and the second time offset quantization value, the method further comprises:
determining that the relay device is transparent to the first UE.

5. The method according to claim 1, wherein sending by the base station the TA-offset quantization value to the UE according to the first time offset quantization value and the second time offset quantization value comprises:
broadcasting by the base station the first time offset quantization value and the second time offset quantization value.

6. The method according to claim 1, wherein sending by the base station the TA-offset quantization value to the UE according to the first time offset quantization value and the second time offset quantization value comprises:
broadcasting by the base station the second time offset quantization value and a sum of the first time offset quantization value and the second time offset quantization value.

7. The method according to claim 5, wherein the UE comprises a first UE, and the first UE is a UE that performs auxiliary communication via the relay device, wherein before sending by the base station the TA-offset quantization value to the UE according to the first time offset quantization value and the second time offset quantization value, the method further comprises:
determining that the relay device is not transparent to the first UE.

8. The method according to claim 1, wherein determining by the base station the first time offset quantization value comprises:
acquiring by the base station the first time offset quantization value comprised in a capability message reported by the relay device, or
determining by the base station a preset default value as the first time offset quantization value.

9. The method according to claim 1, wherein determining by the base station the first time offset quantization value comprises:
acquiring by the base station an index value comprised in a capability message reported by the relay device; and
determining by the base station the first time offset quantization value according to the index value.

10. (canceled)

11. The method according to claim 1, wherein determining by the base station the first time offset quantization value comprises:
in response to not acquiring the first time offset quantization value reported by the relay device, determining by the base station a preset default value as the first time offset quantization value.

12. The method according to claim 1, wherein the first time offset quantization value comprises quantization values corresponding to different frequency bands.

13. The method according to claim 1, wherein a time unit of the first time offset quantization value is an absolute time unit, or a time unit of the first time offset quantization value is a time unit in a wireless communication system.

14. A method for transmission timing adjustment, comprising:
reporting by a relay device a first time offset quantization value to a base station, wherein the first time offset quantization value at least represents a time for which the relay device performs uplink and downlink switching;
receiving by the relay device a timing advance offset (TA-offset) quantization value sent by the base station to a user equipment (UE), wherein the TA-offset quantization value is sent by the base station according to the first time offset quantization value and a second time offset quantization value, and the second time offset quantization value at least represents a time for which the base station performs uplink and downlink switching; and
relaying by the relay device the TA-offset quantization value to the UE.

15. The method according to claim 14, wherein reporting by the relay device the first time offset quantization value to the base station comprises:
reporting by the relay device a capability message to the base station, wherein the capability message comprises the first time offset quantization value or an index value used by the base station to determine the first time offset quantization value.

16. (canceled)

17. A method for transmission timing adjustment, comprising:
receiving by a user equipment (UE) a timing advance offset (TA-offset) quantization value sent by a base station to the UE, wherein the TA-offset quantization value is sent by the base station according to a first time offset quantization value and a second time offset quantization value, the first time offset quantization value at least represents a time for which a relay device performs uplink and downlink switching, and the second time offset quantization value at least represents a time for which the base station performs uplink and downlink switching; and
adjusting by the UE transmission timing according to the TA-offset quantization value.

18. The method according to claim 17, wherein the UE performs auxiliary communication via the relay device, and the TA-offset quantization value comprises the first time offset quantization value and the second time offset quantization value, wherein adjusting by the UE the transmission timing according to the TA-offset quantization value comprises:
adjusting by the UE transmission timing T_TA according to the first time offset quantization value and the second time offset quantization value, where
$$T\_TA = ( N\_TA + N\_TA , offset 1 + N\_TA , offset 2 ) * Tc ;$$
where N_TA is a timing advance (TA) quantization value sent by the base station, N_TA,offset1 is the first time offset quantization value, N_TA,offset2 is the second time offset quantization value, and Tc is a predefined time unit.

19. The method according to claim 17, wherein the UE performs auxiliary communication via the relay device, and the TA-offset quantization value comprises a sum of the first time offset quantization value and the second time offset quantization value, wherein adjusting by the UE the transmission timing according to the TA-offset quantization value comprises:
adjusting by the UE transmission timing T_TA according to the first time offset quantization value and the sum, where
$$T\_TA = ( N\_TA + N\_TA , offset {1}^{′} ) * Tc ;$$
where N_TA is a timing advance (TA) quantization value sent by the base station, N_TA,offset1′ is a sum of the first time offset quantization value and the second time offset quantization value, and Tc is a predefined time unit.

20.-23. (canceled)

24. An apparatus for transmission timing adjustment, the apparatus comprising:
one or more processors; and
a memory for storing instructions executable by the one or more processors;
wherein the executable instructions when collectively executed by the one or more processors cause the apparatus to perform the method of claim 1.

25. An apparatus for transmission timing adjustment, the apparatus comprising:
one or more processors; and
a memory for storing instructions executable by the one or more processors;
wherein the executable instructions when collectively executed by the one or more processors cause the apparatus to perform the method of claim 14.

26. A transmission timing adjustment apparatus, comprising:
one or more processors; and
a memory for storing instructions executable by the one or more processors;
wherein the executable instructions when collectively executed by the one or more processors cause the apparatus to perform the method of claim 17.
